(19) United States
(12) Patent Application Publication
(10) Pub. No.: US 2023/0270307 A1
(43) Pub. Date: Aug. 31, 2023

(54) SUCTION DEVICE AND METHOD FOR OPERATING A SUCTION DEVICE

(71) Applicant: Vorwerk & Co. Interholding GmbH, Wuppertal (DE)

(72) Inventors: Pablo Mosquera Michaelsen, Mülheim (DE); Jan Bärhausen, Köln (DE); Christoph Spitthöver, Wuppertal (DE)

(21) Appl. No.: 18/105,914

(22) Filed: Feb. 6, 2023

(30) Foreign Application Priority Data
Feb. 14, 2022 (EP) 22156594.8

(51) Int. Cl. A47L 9/28; G05D 23/19; A47L 5/28

(52) U.S. Cl. CPC A47L 9/2842; G05D 23/1917; A47L 9/2831; A47L 5/28; A47L 9/2889

(57) ABSTRACT

A suction device with at least one blower with a motor, at least one temperature sensor, and at least one control device. A method for operating a suction device as well as a computer program product is also provided. The suction device, as well as a method for operating a suction device and a computer program product, which prevents overheating of components within the suction device and simultaneously ensures energy efficiency, are realized in that the control device is designed and arranged to throttle or increase, at least temporarily, one operational parameter of the motor, depending on a comparison of a temperature value of the temperature sensor with at least one temperature threshold value.

### CROSS REFERENCE TO RELATED APPLICATIONS

This application claims the benefit of priority under 35 U.S.C. § 119 to European Patent Application No.: 22156594.8, filed Feb. 14, 2022, the contents of which is incorporated herein by reference in its entirety.

### FIELD

The invention relates to a suction device with at least one blower with a motor, at least one temperature sensor, and at least one control device. The invention furthermore relates to a method for operating a suction device as well as a computer program product.

### BACKGROUND

The statements in this section merely provide background information related to the present disclosure and several definitions for terms used in the present disclosure and may not constitute prior art.

Suction devices and methods for operating a suction device are known as conventional technology in a variety of configurations. Generic suction devices can be, for example, vacuum cleaners, hand vacuum cleaners, suction robots, or suction-mopping robots. In the case of suction devices, operating at a high ambient temperature or throttling the suction air stream, for example when used on long-pile carpets, can lead to a reduction in the cooling of the motor, with the result that motor components such as motor bearings or also individual components in the vicinity of the motor, for example electronic components, heat up. In particular, to prevent an overheating of the motor bearings or electronic components, it is known to provide bypass air vents which allow the suction of additional ambient air. Furthermore, it is known that a control unit causes a shutdown of the suction device in the case of intense heating within the housing of the suction device.

However, the solutions known from conventional technology are, especially in the case of battery-powered suction devices, at the expense of the battery life, since unusable air movements are generated.

Therefore, an objective of the present disclosure is to specify a suction device, as well as a method for operating a suction device and a computer program product which prevent an overheating of components within a suction device and simultaneously ensure energy efficiency.

### SUMMARY

The aforementioned objective of the present disclosure is solved with a generic suction device comprising at least one blower with a motor, at least one temperature sensor and at least one control device, wherein the control device is designed and arranged such that at least one operating parameter of the motor is throttled or increased at least temporarily depending on a comparison of a temperature value of the temperature sensor with at least one temperature threshold value. The control device preferably has means for carrying out the comparison as well as the throttling or increasing as described.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 shows an embodiment of a suction device in at least partially sectioned view;

FIG. 2 shows another embodiment of a suction device in at least partially sectioned view; and

FIG. 3 shows an embodiment of a schematic sequence of a process according to the teachings of the present disclosure.

The drawings are provided herewith for purely illustrative purposes and are not intended to limit the scope of the present invention.

### DETAILED DESCRIPTION

The following description is merely exemplary in nature and is in no way intended to limit the present disclosure or its application or uses. It should be understood that throughout the description, corresponding reference numerals indicate like or corresponding parts and features.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

The present disclosure generally provides a generic suction device comprising at least one blower with a motor, at least one temperature sensor and at least one control device, wherein the control device is designed and arranged such that at least one operating parameter of the motor is throttled or increased at least temporarily depending on a comparison of a temperature value of the temperature sensor with at least one temperature threshold value.

Preferably, the suction device is a cleaning device, in which a cleaning function will be at least partially carried out by using a suction air stream, for example a vacuum cleaner, a hand vacuum cleaner, a suction robot, or a suction-mopping robot. The suction device has at least one blower with a motor, wherein advantageously at least one suction air stream can be generated with the blower in a suction channel of the suction device.

Furthermore, the suction device has at least one filter unit which is arranged such that it is flowed through by the suction air stream while operating to remove the suction material from the suction air stream. The filter unit has, for example, a filter bag of filter fleece, a cleanable multi-use-filter, or a filter cyclone. In any case, the filter unit has a separation device that is suitable for cleaning the suction material out of the suction air stream.

The at least one, in particular exactly one, temperature sensor is preferably arranged within the housing of the suction device. The temperature sensor preferably has an NTC resistor. For example, the temperature sensor is arranged such that the temperature of the suction air stream is detectable after exiting the blower, preferably of at least one of the electronic components exposed to this suction air stream, for example a circuit board or the control device, in particular a circuit board comprising the control device. The control device comprises advantageously at least one data processing device with at least one processor and at least one storage means for storing data. The temperature sensor is preferably arranged on at least one of the circuit boards, in particular a circuit board with the control device. The temperature sensor is advantageously arranged on one of the main circuit boards of the suction device. It is alternatively or additionally provided that at least one temperature sensor is arranged such that a temperature of at least one motor bearing can be detected, at least indirectly.

The blower, preferably the motor of the blower, can be operated with adjustable operational parameters, in particular by the user. Operational parameters of the motor are, for example, rotational speed, power, and/or torque. The user usually selects a desired suction power level for this via a switch or an operating menu. Furthermore, it is provided that the suction power desired by the user can be adjusted continuously, for example with a slider. Based on the user's selection, the motor is controlled such that it is operated with the operational parameters assigned to the suction power levels, for example a specific rotational speed, specific power and/or a specific torque. In the present specification, the described procedural steps for the suction device are preferably to be understood that the control device is designed and arranged such that these procedural steps are initiated by the control unit.

The main heat source for the electronic components in the housing of a suction device is the blower with the motor. In particular, in order to prevent overheating of the motor and/or of the motor bearings and/or of the electronic components while running the suction device, the control device is designed and arranged so as to throttle and/or increase at least one operational parameter of the motor, e.g., the rotational speed, the power and/or the torque, at least temporarily, depending on a comparison of at least one temperature value of the temperature sensor with at least one temperature threshold value. At a predetermined time, at predetermined intervals, and/or continuously, at least one temperature value is determined with the temperature sensor and in particular transmitted to the control device or captured by it. The temperature value is compared with at least one predetermined temperature threshold value.

Depending on the result of the comparison, for example, if it undershoots, reaches, or exceeds, at least one operational parameter of the motor is at least temporarily throttled or increased. “At least temporarily” means in particular that an operational parameter remains throttled or increased until the result of the comparison gives another result with regards to the temperature threshold value or another temperature threshold value. It is also provided that the throttling or increasing occurs after the comparison for a predetermined period of time. After the period of time runs out, another measurement of a temperature threshold value occurs and, depending on the result, for example, the throttling is maintained, or there is additional throttling or an increase of the operational parameters to the initial values prior to the throttling.

If the measured temperature value, for example, exceeds the temperature threshold value, at least one operational parameter of the motor will be throttled, for example throttled until the temperature value falls below or reaches the temperature threshold value. If the temperature value falls below a predetermined temperature threshold value, at least one operational parameter of the motor can be increased, in particular up to a maximum value of the operational parameter determined by the user by selecting the suction power level or by the design of the motor.

Particularly preferably, it is provided that the motor rotational speed is throttled or increased depending on at least one temperature value of the temperature sensor. Furthermore, it is particularly provided that a plurality of operational parameters or a combination of operational parameters are throttled or increased, for example the rotational speed or power of the motor. The control unit, furthermore, is designed and arranged such that measurement of the temperature value and the comparison are carried out essentially continuously, regularly, in specific time intervals, event-controlled, e.g. when switching on, and/or for specific periods of time.

According to one aspect of the present disclosure it is therefore provided to change, in particular to throttle or increase, at least one operational parameter of the motor depending on the current temperature of the electronic components, especially of a circuit board with the control unit, at least temporarily. The motor and/or a motor bearing and/or electronic components, for example a circuit board with the control unit, is/are thereby protected from overheating.

The present disclosure is also based on the recognition that the temperature at two places in the housing is fundamentally significant for protection from the overheating of a suction device, namely the temperature of a motor bearing and the temperature of a circuit board, preferably a control circuit board, in particular on a side of the circuit board facing the motor. Experimentally, a correlation between the temperature of the circuit board and the temperature of the motor bearing could be established in the case of a known arrangement of the circuit board and the motor bearing, so that control based on temperature on the circuit board preferably alone is sufficient for protection from overheating. According to another aspect of the present disclosure, at least one reduced, namely throttled, maximum operational parameter is therefore established, depending on the current temperature at the temperature sensor, preferably the temperature of the electronic components located in the vicinity of the temperature sensor. The control unit therefore constantly allows the highest possible suction power that matches the current temperature value—limited by the suction power level selected by the user, while ensuring protection against overheating of the motor and/or motor bearings and/or electronic components. In spite of warming, a throttled operation of the suction device is made possible in any case.

Compared to the use of a bypass air vent, the present disclosure has the advantage that the assembly space as well as the manufacturing tolerances are reduced and the operating power is used efficiently. Compared to a temperature-controlled switching off of the suction device, the present disclosure has the advantage that, furthermore, operation with a throttled motor rotational speed is possible until the components protected from overheating have cooled down. A throttling is not noticeable or only very slightly noticeable for the user. Similarly, at least one operational parameter, in particular the throttled operational parameter, for example the motor rotational speed, can be increased if the measured temperature once again falls below the temperature threshold value.

According to an embodiment of the suction device, it has been found to be advantageous if it is provided that the throttling or increasing of at least one operational parameter occurs in steps or without steps. It is provided in particular that the throttling or increasing of the operational parameter, for example the rotational speed of the motor, occurs by a fixed amount. Similarly, it is provided in particular that the increasing of the operational parameter occurs by a fixed amount. It is additionally provided that the control device is designed and arranged such that if the temperature threshold value is exceeded, the operational parameter, in particular the rotational speed, will be reduced by a fixed amount. In the case of a further excess after a predetermined time frame, the operational parameter is preferably again dropped by a fixed amount. An effective cooling of the electronic components can therefore be achieved by the throttling. As soon as a reduction in temperature at the temperature sensor is achieved, the operational parameters can be increased again, for example in steps or without steps. Furthermore, it is preferably provided that both throttling as well as increasing the operational parameter occurs without steps.

In this context, according to a further embodiment of the suction device, it has been found to be advantageous if it is provided that a degree of deviation of the at least one temperature value from at least one temperature threshold value is determined, and that using the degree of deviation, a degree of throttling or a degree of increasing is determined, in particular calculated, and applied. If, for example, the temperature threshold value is exceeded or undershot by 10%, the operational parameter, for example, in particular the rotational speed, for example, is throttled or increased by 10% as well. It is provided that the ratio between the degree of deviation of the temperature threshold value and the degree of throttling or the degree of increasing is proportional. However, ratios deviating from proportionality are also provided.

According to a further embodiment of the suction device, it is provided that a throttling or increase of an operational parameter that has occurred is maintained until at least one temperature threshold value is reached, is undershot, or is exceeded. For example, throttling of an operational parameter, preferably the speed, is maintained until the temperature threshold value that had originally triggered the throttling is again reached or is undershot. Throttling is then reversed when the temperature falls below or reaches at least one temperature threshold value again.

A further embodiment of the suction device provides that a plurality of temperature threshold values are defined and that at least one, in particular maximum, operating parameter is assigned to each temperature threshold value range. Preferably between seven and nine, in particular exactly eight, temperature threshold value ranges are provided. Advantageously, the operational parameter or parameters assigned to the different temperature threshold value ranges are also distinct from each other. A temperature value of the temperature sensor is compared with the temperature threshold value ranges and assigned to a temperature threshold value range. Advantageously, the temperature value is compared with each of the temperature threshold value ranges before an assigning occurs.

Subsequently, the operational parameter assigned to the selected temperature threshold value range is established as the maximum operational parameter for operation or controls the control device of the motor such that an operation occurs with this maximum allowed operational parameter. The temperature threshold value ranges are preferably kept available in a storage means of the control device or can be retrieved from it by the control device for the steps to be performed.

According to another aspect of the present disclosure, it is provided that, during throttling or increasing, one or more of the temperature threshold value ranges can be skipped in order to establish the maximum allowed operational parameter. For example, if the temperature at the temperature sensor rises abruptly, the maximum permissible operational parameter may be markedly below the current operation. The same applies if the temperature at the temperature sensor abruptly drops. In this case, a higher operational parameter, for example a higher rotational speed than the allowed maximum operational parameter, can be established so that the device can again be operated with increased suction power.

This embodiment, compared to conventional technology, has the advantage that the maximum thermally allowed operational parameter level, for example the rotational speed level, can be reached much more quickly compared to successively going through operational parameters in steps.

The following table shows examples of the temperature threshold value ranges in which throttling of the rotational speed as an operational parameter occurs if the temperature value can be assigned to a temperature threshold value range, and such temperature threshold value ranges in which increasing of the speed can occur.

| | Temperature threshold | Temperature threshold |
|---|---|---|
| Motor speed | value range | value range |
| [revolution/minute] | for throttling | for increasing |
| 95,000 | ≤75° C. | ≤74° C. |
| 80,000 | >75° C. . . . ≤76° C. | >74° C. . . . ≤75° C. |
| 76,000 | >76° C. . . . ≤77° C. | >75° C. . . . ≤76° C. |
| 70,000 | >77° C. . . . ≤78° C. | >76° C. . . . ≤77° C. |
| 63,000 | >78° C. . . . ≤79° C. | >77° C. . . . ≤78° C. |
| 58,000 | >79° C. . . . ≤80° C. | >78° C. . . . ≤79° C. |
| 47,000 | >80° C. . . . ≤81° C. | >79° C. . . . ≤80° C. |
| 30,000 | >81° C. . . . ≤82° C. | — |
| 0 (out) | >82° C. | — |

In particular, in order to prevent unavoidable damage to the suction unit, according to a further embodiment it is provided that the motor is switched off when a maximum temperature threshold is exceeded. If a sufficient reduction of the temperature at the temperature sensor cannot be achieved despite throttling an operational parameter, for example the rotational speed, a shutdown of the suction device must nevertheless occur if a maximum temperature at the temperature sensor is exceeded. This emergency shutdown is effected advantageously by the control device. The maximum temperature threshold is defined, for example, from the minimum of the maximum allowed temperature of the electronic components, for example a circuit board, and the maximum allowed temperature of the motor bearing—taking into account the empirically determined correlation.

According to an additional embodiment of the suction device, it is provided that at least a second temperature sensor is available, and that the throttling or increasing occurs depending of the comparatively higher temperature value of both temperature sensors. Preferably at least one temperature sensor is arranged on a circuit board and at least one temperature sensor is arranged on the motor bearing. The throttling or increasing then occurs depending on the respective higher temperature value. It is also provided that for the first temperature sensor and the second temperature sensor, different temperature threshold values or temperature threshold value ranges are defined, so that throttling or increasing only occurs in each case if the temperature values of both temperature sensors fulfill the corresponding criteria for this, or that throttling always occurs if at least one temperature sensor exceeds the critical temperature values.

According to a further embodiment it is provided that, in order to advantageously prevent damage to the suction device at very high ambient temperatures or already very high device temperatures, at least one temperature value is determined each time the suction device is switched on, and that, if necessary, throttling or increasing occurs immediately after switching on if the comparison of the temperature value with at least one temperature threshold value or a temperature threshold value range has yielded a corresponding necessity or a corresponding release.

Furthermore, the present disclosure relates to a method with procedural steps which have been described for the above embodiments of the suction device.

The initially stated objective of the present disclosure is further achieved with a method for operating a suction device with at least one blower with a motor, at least one temperature sensor and at least one control device. Preferably, this is a suction device according to one of the embodiments described above. The method comprises at least the following method steps:
Measuring at least one temperature value with the temperature sensor;
Comparing the measured temperature value with at least one temperature threshold value; and
Throttling or increasing at least one operational parameter of the motor depending on the result of the comparison.

The measurement of at least one temperature value with the temperature sensor occurs continuously, in predetermined intervals, or at predetermined times. The temperature value, preferably each temperature value, is compared with at least one temperature threshold value regarding the comparison. Depending on the result of the comparison, for example matching, exceeding or undershooting, throttling or increasing of at least one operational parameter of the motor occurs, for example the rotational speed, the power, or the torque, in particular as described in the preceding embodiments for the suction device.

According to a first embodiment of the method, it is provided that a comparison with a multitude of temperature threshold values occurs, in particular in a storage means, and that at least one, in particular maximum, operating parameter is assigned to each temperature threshold value. The operational parameter determined on the basis of the comparison is then preferably established as the maximum operational parameter for operation, or the operation of the suction device occurs on the basis of this operating parameter.

A further embodiment of the method provides that the throttling or increasing, as described above for the embodiment of the suction device, occurs in steps or without steps. It is also provided that a comparison with temperature threshold value ranges occurs, as has been described above in the context of the embodiments of the suction device.

A further embodiment relates to a method in which the measurement of a temperature value occurs at least immediately after the suction device is switched on, so that operation occurs, if necessary, with at least one throttled or increased operational parameter, depending on the result of the comparison.

The present disclosure further relates to a suction device, in particular with a control device, which is designed and arranged for carrying out a method according to the embodiments described above.

The initially stated objective of the present disclosure is further solved by a computer program product which contains instructions for causing the control device of the suction apparatus to carry out a method according to one of the embodiments described above.

Additional advantageous embodiments of the present disclosure result from the following figure descriptions.

In the different figures of the drawing, same parts are always provided with the same reference numbers.

Regarding the following description, it is claimed that the invention is not limited to the embodiment and thereby not limited to all or several characteristics of described characteristic combinations, rather each individual partial characteristic of the/each embodiment is also of significance for the subject of the invention independent of from all other partial characteristics described in connection therewith for itself and also in combination with any characteristics of another embodiment.

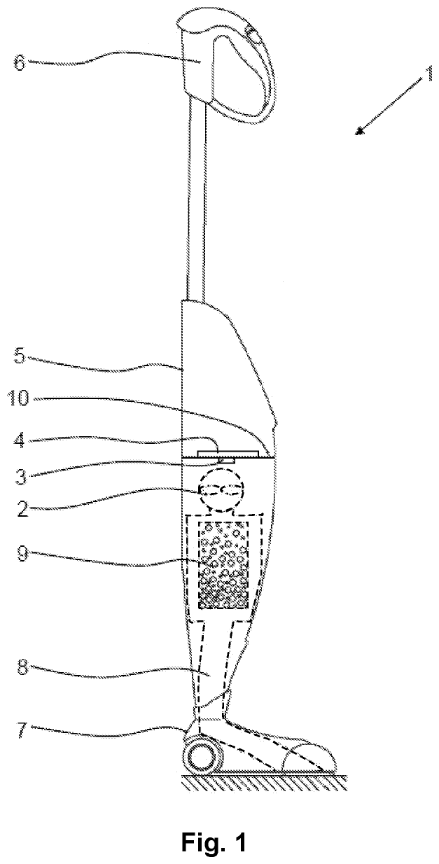

FIG. 1 shows an embodiment of a suction device 1 with at least one blower 2 with a motor, at least one temperature sensor 3 and a control device 4. The suction device 1 has a housing 5 in which the essential components of the suction device 1 are arranged. A handle 6 is arranged on the housing 5, with which the suction device 1 can be guided and operated by a user. The blower 2 with the motor is arranged inside the housing 5 such that a suction air flow can be generated in a suction channel 8 starting from an attachment device 7, which is designed here as a floor nozzle. The suction air stream is freed from suction material by a filter unit 9. The control device 4 is arranged together with the temperature sensor 3 on a circuit board 10. The temperature sensor 3 is arranged in particular on a side of the circuit board 10 oriented in the direction of the blower 2, since the greatest temperature load is to be expected at this location.

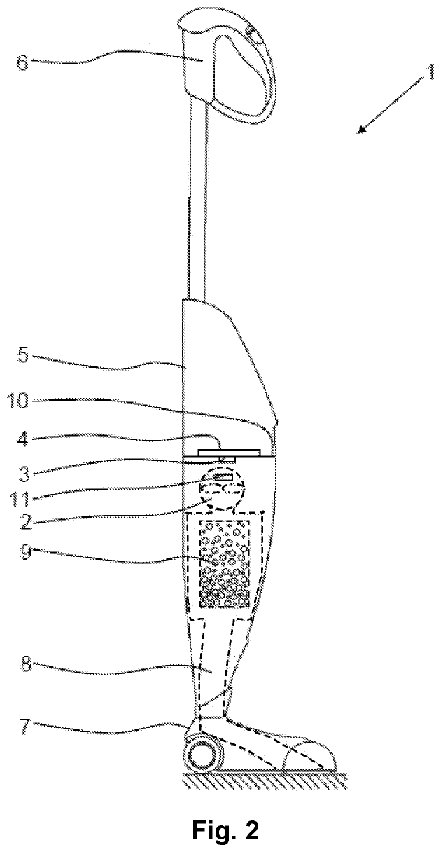

FIG. 2 shows a further embodiment of a suction device 1 with at least one blower 2 with a motor, at least one temperature sensor 3 and a control device 4. The suction device 1 has a housing 5. A handle 6 is arranged on the housing 5, with which the vacuum cleaner can be guided and operated by a user. The blower 2 with the motor is arranged inside the housing 5 such that a suction air flow can be generated in a suction channel 8 starting from an attachment device 7, which is designed here as a floor nozzle. The suction air stream is freed from suction material by a filter unit 9. The control device 4 is arranged together with the temperature sensor 3 on a circuit board 10.

FIG. 2, furthermore, shows a second temperature sensor 11, which is arranged on a motor bearing of the blower 2. The throttling or increasing of at least one operational parameter of the motor occurs preferably depending on the temperature value of the temperature sensor 3, 11 which detects the higher temperature of the two temperature sensors 3, 11.

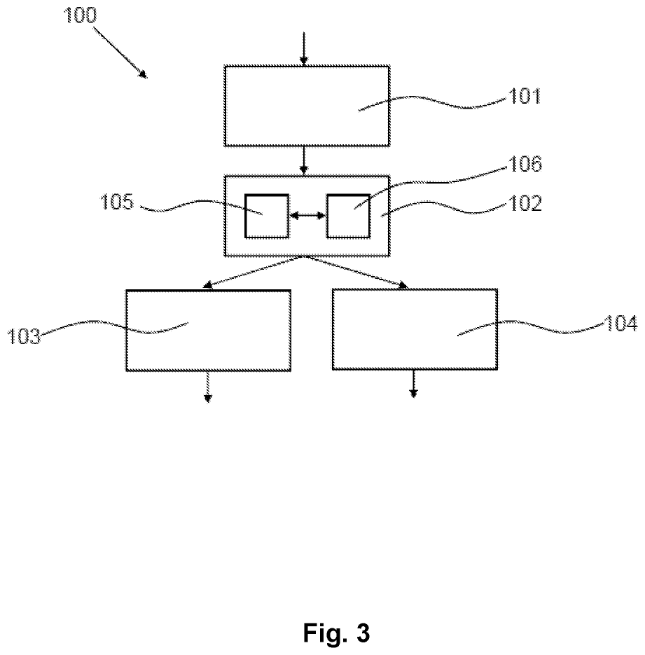

FIG. 3 shows an embodiment of a schematic sequence of a method 100 according to the invention. The method is designed for operating a suction device 1 with at least one blower 2 with a motor, at least one temperature sensor 3 and at least one control device 4. First, the measurement 101 of at least one temperature measurement value 105 occurs with the temperature sensor 3. Subsequently, a comparison 102 of the measured temperature value 105 with at least one temperature threshold value 106 occurs. Subsequently, throttling 103 or increasing 104 of at least one operational parameter, for example the rotational speed, the power, and/or the torque, occurs depending on the result of the comparison 102. If, for example, a predetermined temperature threshold value 106 is exceeded, throttling 103 preferably occurs, and if the temperature falls below a predetermined temperature threshold value 106, increasing 104 preferably occurs. Increasing 104 occurs at a maximum up to the operational parameter or operational parameters which have preferably been selected by a user in the form of a suction power level.

According to the present disclosure, it is also provided that the comparison 102 occurs with a plurality of temperature threshold values 106 or temperature threshold value ranges. Preferably the method is continuously repeated in order to ensure a constant comparison of the operational parameters to the temperature at the temperature sensor 3.

The invention is not limited to the illustrated and described embodiments, but rather also encompasses all of the equivalent embodiments in the sense of the invention. It is expressly emphasized that the embodiments are not limited to all of the characteristics in combination, rather each individual partial characteristic may also have a significance related to the invention independent from all of the other partial characteristics. Furthermore, the invention has not yet been limited to the combination of characteristics defined in any specific embodiment either, but can also be defined by any other combination of certain characteristics of all the individual characteristics revealed as a whole. This means that essentially virtually any individual characteristic can be omitted or replaced by at least one individual characteristic revealed elsewhere in the application. In other words, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. A suction device comprising at least one blower with a motor, at least one temperature sensor and at least one control device,
wherein the control device is designed and arranged to at least temporarily throttle or increase at least one operational parameter of the motor depending on a comparison of a temperature value of the temperature sensor with at least one temperature threshold value.

2. The suction device as cited in claim 1, wherein at least one operational parameter is throttled if one initial temperature threshold value is reached or exceeded and/or that at least one operational parameter is increased if a second temperature threshold value is reached or undershot.

3. The suction device as cited in claim 1, wherein the throttling or increasing of at least one operational parameter occurs in steps or without steps.

4. The suction device as cited in claim 1, wherein at least one degree of the deviation of the temperature value of at least one temperature threshold value is determined, and in that a degree of throttling or increasing is determined and applied using the degree of deviation.

5. The suction device as cited in claim 1, wherein a throttling or increasing of an operational parameter that has occurred is maintained until at least one temperature threshold value is reached, undershot, or exceeded.

6. The suction device as cited in claim 1, wherein a plurality of temperature threshold value ranges are defined, that at least one operational parameter is assigned to each temperature threshold value range, that at least one temperature value of the temperature sensor is compared and the temperature value is assigned to one temperature threshold range, and that the operational parameter assigned to the temperature threshold range is established as the maximum operational parameter for operating the motor.

7. The suction device as cited in claim 1, wherein in the case of exceeding a maximum temperature threshold value, a shutdown of the motor will be effected by the control device.

8. The suction device as cited in claim 1, wherein at least a second temperature sensor is provided, and that throttling or increasing occurs depending on the higher temperature value of both temperature sensors.

9. The suction device as cited in claim 1, wherein with each switching on of the suction device, at least one temperature value is determined, and that throttling or increasing occurs immediately after the switching on.

10. A method for operating a suction device comprising at least one blower with a motor, at least one temperature sensor, and at least one control device, encompassing at least the following method steps:
Measuring at least one temperature value with the temperature sensor,
Comparing the measured temperature value with at least one temperature threshold value, and
Throttling or increasing at least one operational parameter of the motor depending on the result of the comparison.

11. The method as cited in claim 10, wherein a comparison of the temperature value occurs with a multitude of temperature threshold values, in that at least one operational parameter is assigned to each temperature threshold value and that the, assigned operational parameter based on the comparisons, is established as the maximum operational parameters for the operation.

12. A method as cited in claim 10, wherein a plurality of temperature threshold value ranges are defined, that at least one operational parameter is assigned to each temperature value range, that the comparison of at least one temperature value of the temperature sensor with the temperature threshold value ranges occurs and the temperature value is assigned to a temperature value threshold range, and that the operational parameter assigned to the temperature value threshold range is established as the maximum operational parameter for operating.

13. The method as cited in claim 10, wherein the measuring of a temperature value occurs at least immediately after switching the suction device on, so that the operation occurs with at least one throttled or increased operational parameter, as is necessary.

14. A computer program product that contains instructions to prompt a control device of a suction device to carry out the method as cited in claim 10.
